(19) United States
(12) Patent Application Publication
(10) Pub. No.: US 2016/0348733 A1
(43) Pub. Date: Dec. 1, 2016

(54) ELASTIC JAW COUPLING

(71) Applicant: CENTA-ANTRIEBE KIRSCHEY GmbH, Haan (DE)

(72) Inventors: Jochen Exner, Hennef (DE); Martin Fitsch, Wuppertal (DE)

(21) Appl. No.: 15/140,813

(22) Filed: Apr. 28, 2016

(30) Foreign Application Priority Data
May 27, 2015 (DE) 102015108322.1

(51) Int. Cl. F16D 3/68

(52) U.S. Cl. CPC F16D 3/68

(57) ABSTRACT

The invention pertains, among other things, to an elastic claw coupling (10) for transmitting torque from a drive element (12) to a load element (13), wherein the claw coupling comprises a first coupling part (14) assigned to the drive element and a second coupling part (15) assigned to the load element, both of which rotate about a common rotational axis (13), wherein radially mountable claws (18, 19) are arranged on both coupling parts and extend radially outward from the respective coupling part, as well as axially so as to achieve an axial overlap with the respective other coupling part, and wherein two claws (19a, 18a) that are arranged angularly adjacent about the rotational axis, respectively form an accommodation space (32a) for an elastic body (25, 26) between one another. The peculiarity of the invention can be seen, among other things, in that the claws of both coupling parts are realized identically.

The invention pertains to an elastic claw coupling according to the preamble of claim 1.

A claw coupling of this type is known, for example, from DE 10 2013 004 583 of applicant.

The claw coupling described in this publication has successfully proven itself in practical applications. However, the manufacture of the coupling described in this publication is quite elaborate.

Based on the initially described prior art, the invention aims to enhance an elastic shaft coupling according to the preamble of claim 1 in such a way that a simplified construction can be achieved.

This objective is attained with the characteristics of claim 1.

The inventive principle essentially consists of realizing the claws to be arranged on the two coupling parts of an elastic claw coupling identically. The number of identical parts can thereby be increased such that the manufacturing costs and the stock-keeping expenditures can be reduced. This makes it possible to realize a simplified construction and to simultaneously preserve the very satisfactory coupling properties.

The invention pertains to an elastic claw coupling for transmitting torque, particularly very high torque, from a drive element to a load element. To this end, the claw coupling comprises a first coupling part and a second coupling part. The first coupling part is assigned to the drive element and, in particular, mounted on the drive element. For example, the coupling part may be mounted on the flywheel of an engine.

The second coupling part is assigned to the load element and, in particular, mounted on the load element. The coupling part may be fixed, in particular, on an output shaft.

The first coupling part and the second coupling part rotate about a common rotational axis. Both coupling parts are realized, in particular, in the form of a circular-cylindrical toroid that may have an identical or identically designed outer surface, particularly an identical outside diameter, and, in particular, an identically designed inner surface.

In the inventive claw coupling, radially mountable claws are arranged on both coupling parts. The claws therefore can be mounted on the coupling parts radially with the aid of screw elements and likewise removed radially.

The claws extend radially outward from the respective coupling part, on which they are mounted. Each claw furthermore extends axially from the coupling part, on which it is mounted, to the other coupling part. This extent axially is chosen such that the claw axially overlaps the respective other coupling part.

In other words, claws of a first type are arranged on the first coupling part and claws of a second type are arranged on the other coupling part. The claws of the first type engage into the intermediate spaces arranged between the claws of the second type in such a way that a star-like gearing of sorts is formed. In this context, this is also referred to as a star coupling.

The number of claws arranged on the first coupling part corresponds to the number of claws arranged in the second coupling part.

An angularly alternating arrangement of claws of the first type that are mounted on the first coupling part, and claws of the second type that are mounted on the second coupling part, is realized.

A space for accommodating an elastic body is respectively located between two claws that are arranged angularly adjacent about the rotational axis. It is preferred that the number of elastic bodies exactly corresponds to the total number of claws.

The elastic bodies are preferably realized in the form of rubbery-elastic roller bodies or comprise such elastic roller bodies. This type of claw coupling is also referred to as a roller coupling.

The inventive coupling consists of an elastic claw coupling that serves for transmitting a torque in a rotationally elastic fashion. The elastic bodies serve for damping vibrations and protect, for example, a transmission arranged on the output side from torque peaks that can occur in the drive element.

According to the invention, it is proposed that the claws of both coupling parts are realized identically. This means that two angularly adjacent claws, i.e. a claw of the first type mounted on the first coupling part and a second claw of the second type mounted on the second coupling part, are realized identically or in essence realized identically. In this way, a mirror-symmetrical installation can be realized.

According to the invention, the different geometries of claws of the first type and claws of the second type used in the prior art are rendered obsolete. The invention has recognized that the claws of both coupling parts can be realized identically and proposes to do so in order to achieve a plurality of identical parts.

According to a second aspect of the invention, the above-defined objective is attained with the characteristics of claim 2.

It is accordingly proposed that the claws are respectively divided into at least two claw segments, wherein the claws of both coupling parts respectively have at least one identically designed claw segment. According to this aspect of the invention, each claw may consist, for example, of two claw segments that can be separably mounted on one another or relative to one another, particularly a foot segment and a head segment. The foot segment and the head segment particularly may divide the claw radially. For example, the foot segment can be directly fixed on the coupling part and the head segment can be directly fixed on the foot segment, e.g. after the foot segment has been fixed on the coupling part. Alternatively, the head segment may likewise be directly fixed on the coupling part after the foot segment has been installed thereon.

The invention ultimately also includes embodiments, in which the head segment and the foot segment are initially mounted on one another, particularly such that they form a handling unit, and this handling unit consisting of the head segment and the foot segment is then collectively mounted on the coupling part.

The invention also includes embodiments, in which only the head segment of different claws on different coupling parts is realized identically, i.e. in which the head segment of a claw of the first type that is mounted on the first coupling part, and the head segment of a claw of the second type that is mounted on the second coupling part, are realized identically.

However, the invention also includes a claw arrangement, in which the foot segment of a claw of the first type that is mounted on the first coupling part, and a foot segment of a claw of the second type that is mounted on the second coupling part, are realized identically.

If the head segment and the foot segment of different claws of both coupling parts are realized identically, the claws of both coupling parts once again consist of claws in the sense of claim 1 that are realized identically and have the peculiar have of being divided into different claw segments.

According to this aspect of the invention, a claw may be divided into two claw segments, as well as into more than two claw segments.

According to an advantageous embodiment of the invention, the head segment of the claw and the foot segment of the claw respectively form a section of a contact surface for the elastic body. In this way, a particularly advantageous geometry can be achieved. An elastic claw coupling can thereby be assembled, in particular, such that one or more foot segments are initially mounted on a coupling part or on both coupling parts, whereupon the elastic bodies are inserted radially and the associated head segment or the associated head segments are ultimately fixed radially. In addition, a simple exchange of elastic bodies can thereby be achieved—if the assembly sequence is reversed—e.g. for repair or maintenance purposes.

According to another advantageous embodiment of the invention, the foot segment and the head segment are realized such that they can be radially mounted on one another. In this way, the claws or the claws segments can be respectively mounted and dismounted in a particularly simple fashion.

According to another advantageous embodiment of the invention, the foot segment and the head segment consist of different materials. This allows an optimized material selection for the different segments and consequently for the different functional sections of a claw, as well as low manufacturing costs.

According to another advantageous embodiment of the invention, the head segment of a claw is realized asymmetrically referred to a central longitudinal axis of the claw. This respectively makes it possible to arrange differently designed elastic bodies or to provide different geometries and/or differently shaped contact surfaces for the elastic bodies on different sides of a claw, as well as to realize, for example, retaining or mounting sections for elastic bodies of a second type.

According to another advantageous embodiment of the invention, an angularly alternating alignment of the head segments is realized. This makes it possible to respectively accommodate different types of elastic bodies angularly alternately.

According to another advantageous embodiment of the invention, the foot segment has a concave, cylindrically curved mounting surface for contacting a cylindrical surface area of the coupling part. In this respect, a close fit between the foot segment and the cylindrical surface area of the preferably toroidal coupling part defined by the outside diameter can be produced.

According to another advantageous embodiment of the invention, both coupling parts are respectively formed by a toroid that has radial screw receptacles for mounting the claws. Since the coupling part is formed by a toroid, the carrier element for the claws can be manufactured in a particularly simple fashion. However, the toroid may also form a particularly ingenious shaft-shaft or shaft-flange coupling. For example, the shaft may penetrate the inside of the toroid. In this case, particularly advantageous and simple mounting options may be considered for mounting the first coupling part and the second coupling part on the respective shaft.

According to another advantageous embodiment of the invention, at least one coupling part also has axial screw receptacles in addition to the radial screw receptacles. For example, these axial screw receptacles serve for the installation of a mounting flange. In this case, the mounting flange has a radial dimension that exceeds the radial dimension of the toroid, particularly to a significant degree.

This makes it possible to produce a shaft-flange connection, in which claws can be radially mounted on both coupling parts. In this respect, the second coupling part, which is realized in the form of a toroid and additionally has axial screw receptacles, is provided as an adapter or auxiliary installation ring of sorts.

The invention furthermore pertains to a group of foot segments of claws for elastic shaft couplings according to claim 12.

According to this aspect of the invention, the above-defined objective is attained with the characteristics of claim 12.

It is accordingly proposed that a first foot segment has a concave mounting surface that is cylindrically curved along a first radius and serves for contacting a cylindrical surface area of the coupling part, and that a second foot segment is with the exception of the design of the mounting surface realized identically to the first foot segment and has a concave mounting surface that is cylindrically curved along a second radius that differs from the first radius and serves for contacting a surface area of the coupling part that is realized cylindrically along the second radius.

The inventive principle consists of realizing different foot segments with different mounting surfaces that are respectively adapted to the curvature of the outer surface area of the coupling part.

In this respect, changing the number of claw elements makes it possible to ensure a large number of identical parts for different hub sizes—wherein it is merely required to adapt the concave curvature of the mounting surface on the foot segment of the claw. Due to the two-part design of the claw with a foot segment and a head segment, it is particularly possible to use identical head segments for different hub sizes. The concave mounting surface on the foot segment can also be produced in a conceivably simple fashion, e.g. by means of a forging process.

Other advantages of the invention result from the non-cited dependent claims, as well as the following description of illustrated embodiments illustrated in the drawings. In these drawings:

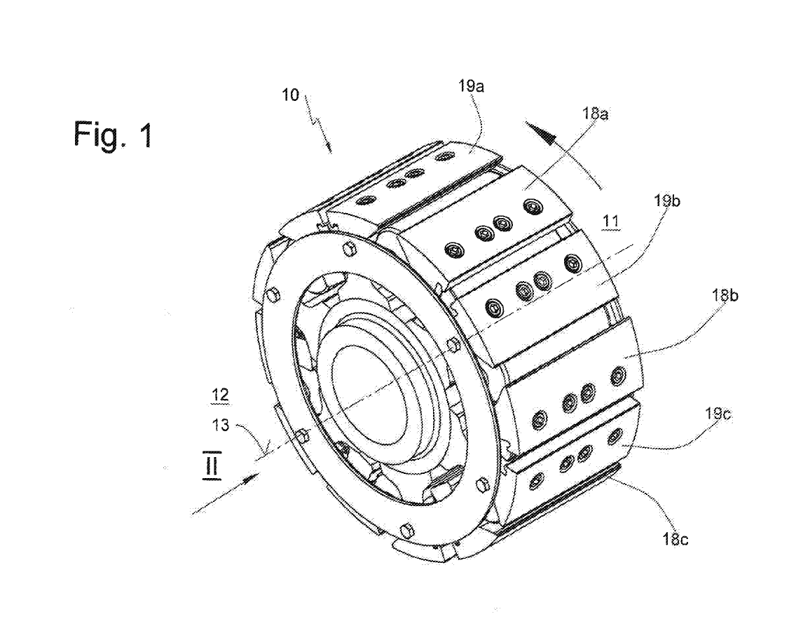

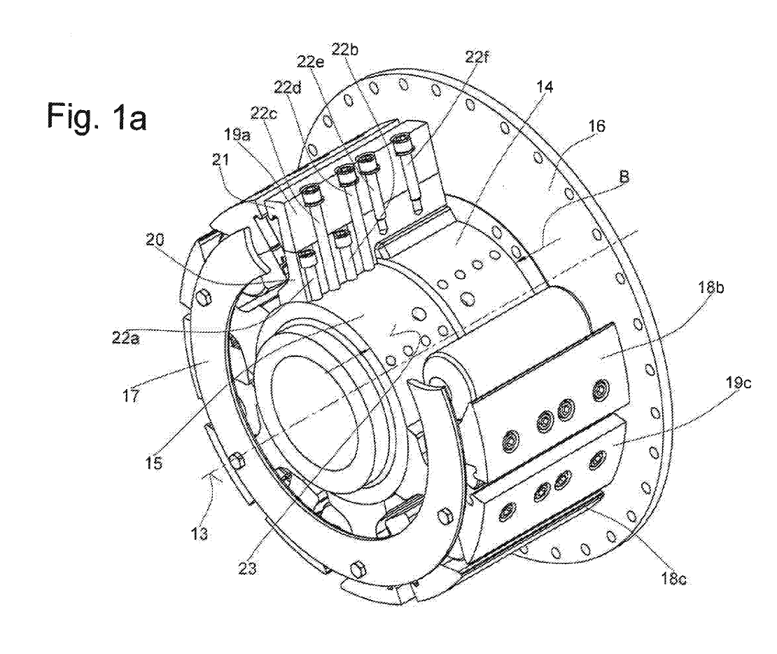

FIG. 1 shows a first illustrated embodiment of an inventive coupling in the form of a schematic perspective view,

FIG. 1a shows the illustrated embodiment according to FIG. 1 in the form of a schematic perspective view that is partially sectioned, wherein a flange is additionally illustrated on the drive element side, and wherein a circumferential segment of the coupling extending over approximately 75 angular degrees is kept free of claws in order to provide a better overview,

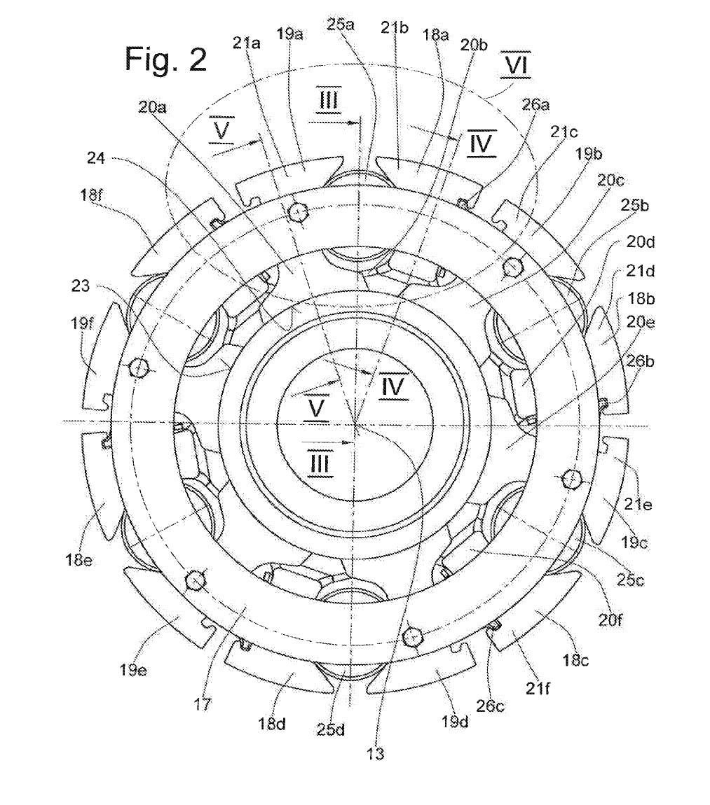

FIG. 2 shows a schematic view of the coupling according to FIG. 1 in the direction of the arrow II in FIG. 1,

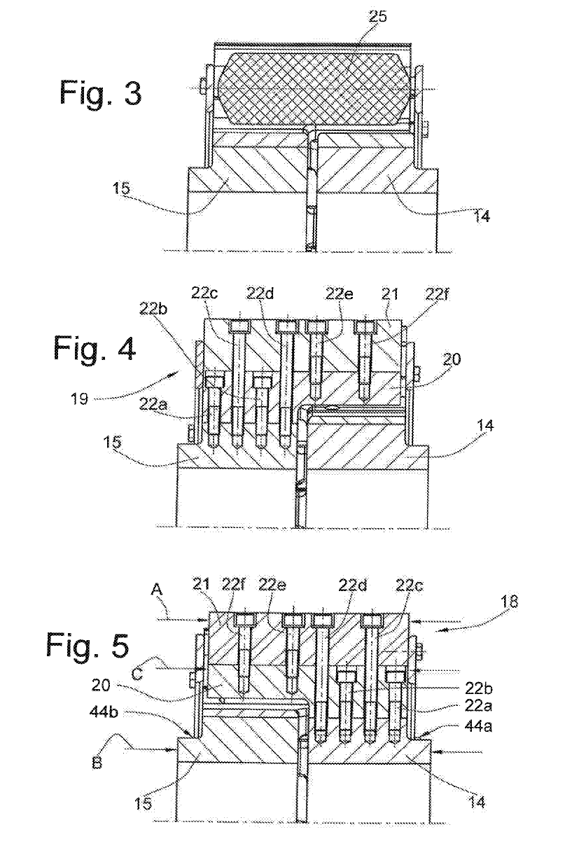

FIG. 3 shows a schematic view in the form of a partial section through the coupling according to FIG. 2 approximately along the line of section in FIG. 2,

FIG. 4 shows a schematic view in the form of a partial section through the coupling according to FIG. 2 approximately along the line of section IV-IV in FIG. 2,

FIG. 5 shows a partially sectioned view of the device illustrated in FIG. 2 approximately along the line of section V-V in FIG. 2, namely in the form of an illustration according to FIG. 4,

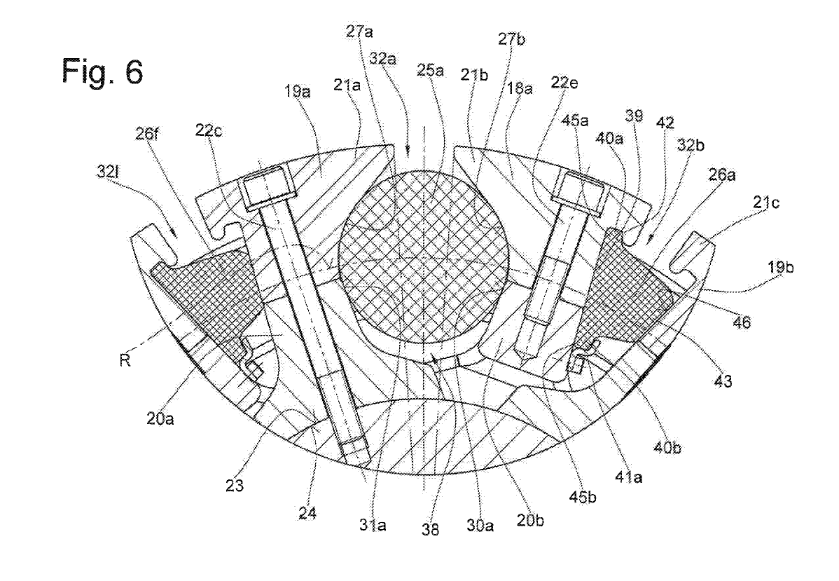

FIG. 6 shows an enlarged schematic view of a region of the coupling according to FIG. 2 that is partially sectioned approximately along the reference circle VI in FIG. 2, wherein the schematic sectional view illustrated in FIG. 6 corresponds to a plane of section that lies behind the paper plane referred to the viewing direction of the observer of FIG. 2,

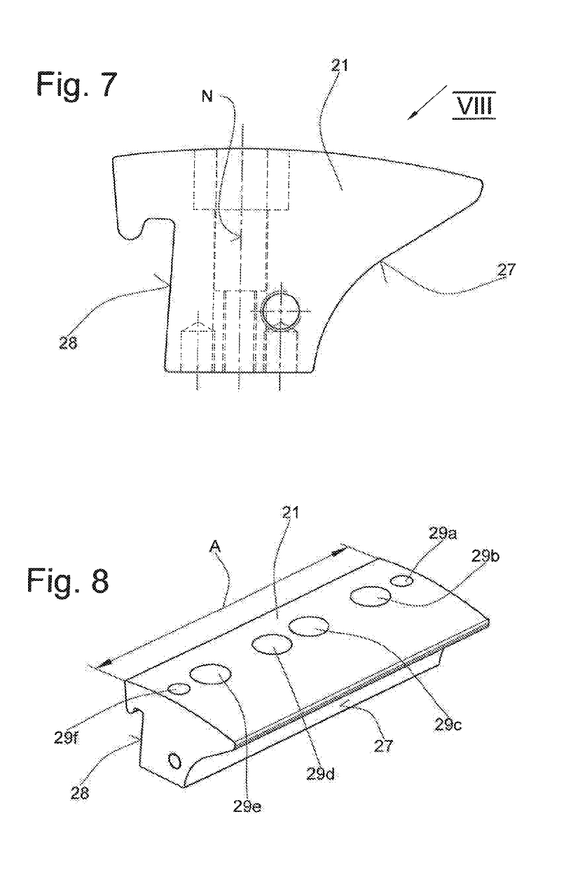

FIG. 7 shows a front view of a head segment of a claw in the form of a partially sectioned schematic view,

FIG. 8 shows the claw according to FIG. 7 in the form of a schematic perspective view approximately in the direction of the arrow VIII in FIG. 7,

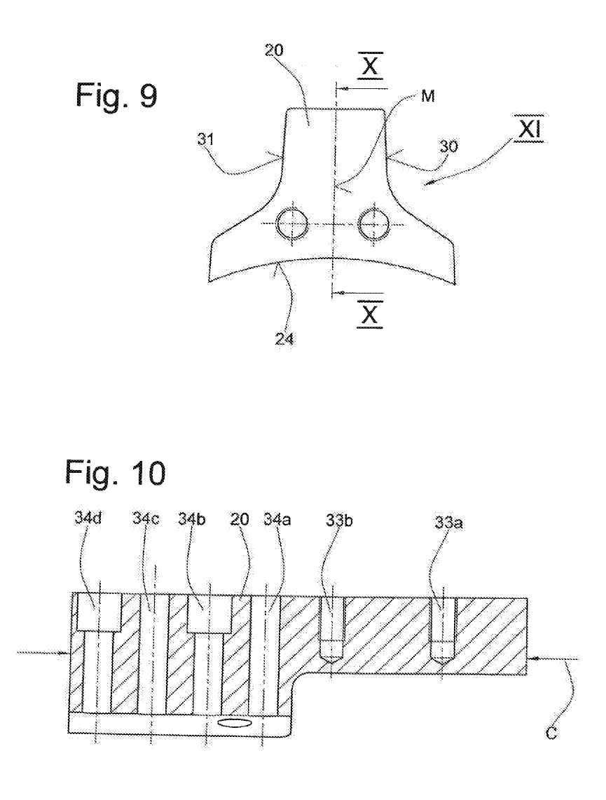

FIG. 9 shows a schematic front view of an individual foot segment of a claw,

FIG. 10 shows a section through the claw according to FIG. 9 approximately along the line of section X-X in FIG. 9,

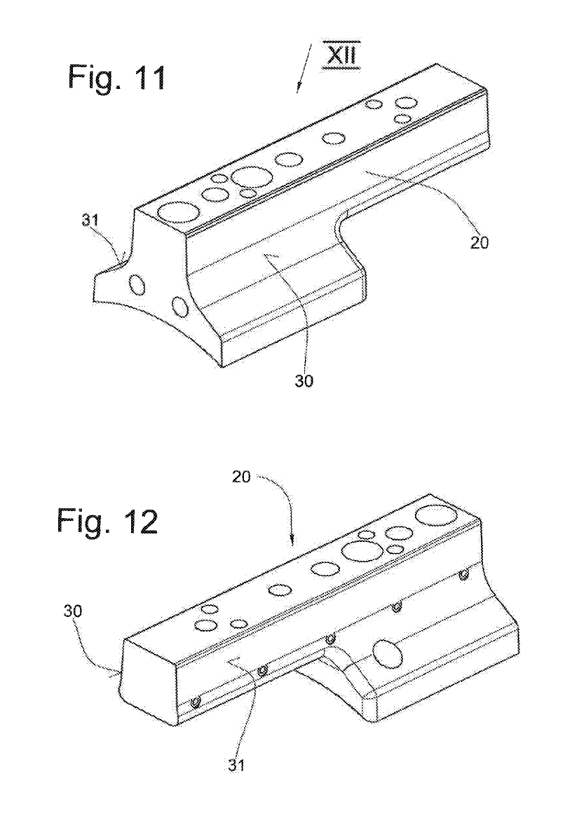

FIG. 11 shows a schematic perspective view of the claw according to FIG. 9 approximately in the direction of the arrow XI in FIG. 9,

FIG. 12 shows a rear view of the claw according to FIG. 11 approximately along the direction of the arrow XII in FIG. 11,

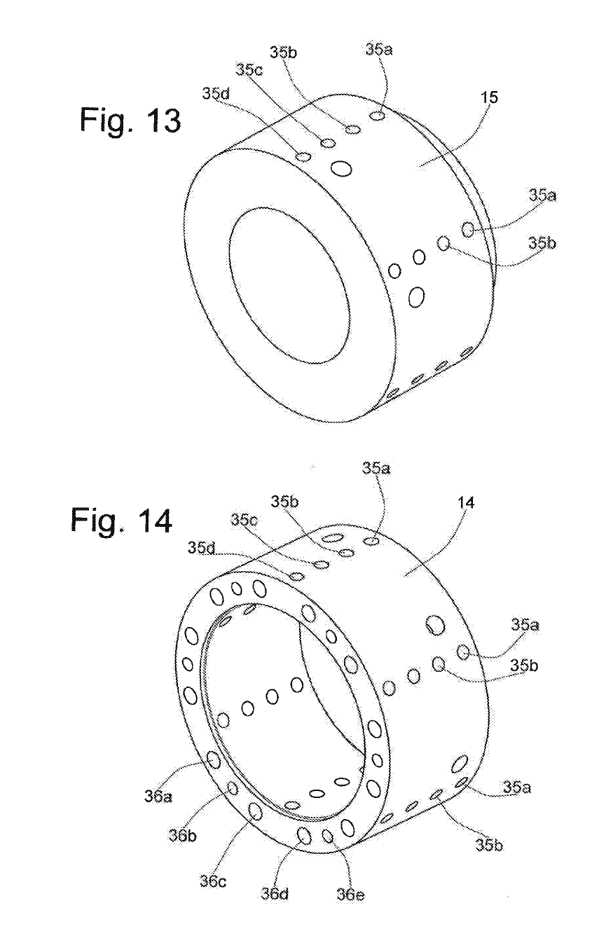

FIG. 13 shows an individual perspective view of a second coupling part with radial screw receptacles,

FIG. 14 shows an illustrated embodiment of a first coupling part in the form of an illustration according to FIG. 13, wherein axial screw receptacles are provided in addition to the radial screw receptacles,

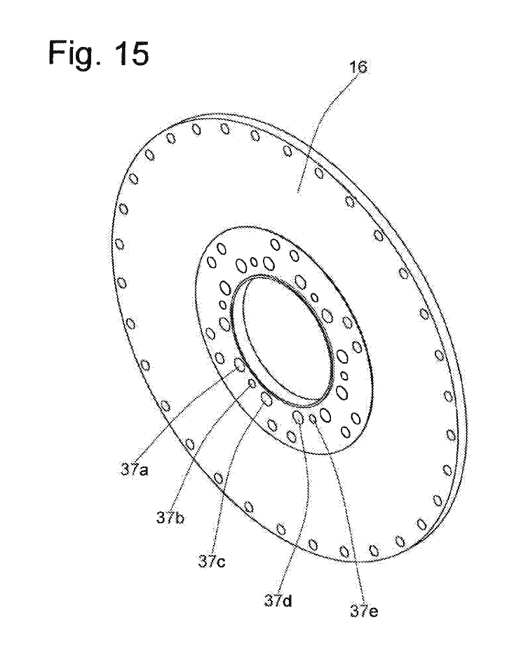

FIG. 15 shows an individual perspective view of a mounting flange for being mounted on the drive element, e.g. on the flywheel of an engine, as well as for being axially mounted on the axial screw receptacles of the first coupling part illustrated in FIG. 14,

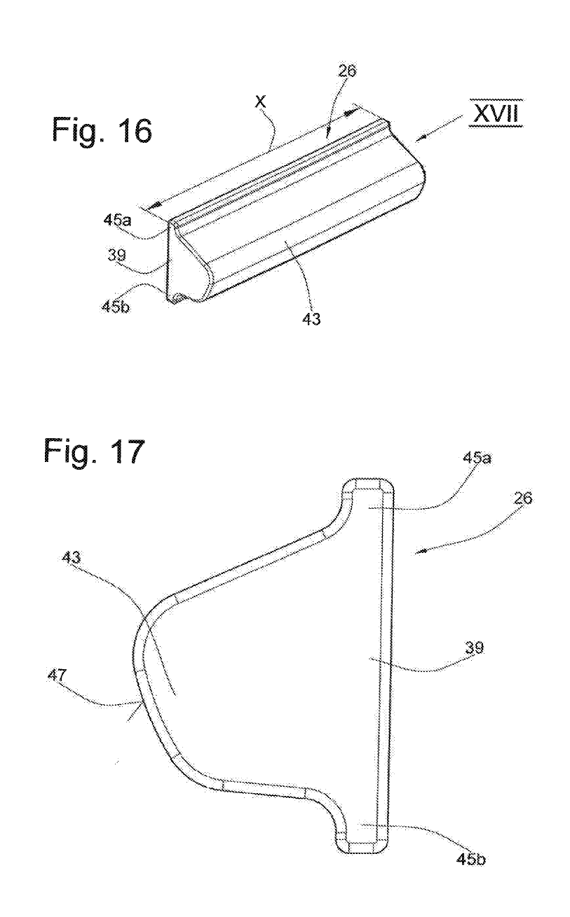

FIG. 16 shows a perspective view of an elastic body of the second type, and

FIG. 17 shows a front view of the elastic body of the second type according to FIG. 16 approximately along the direction of the arrow XVII in FIG. 16.

In the following description of the figures, illustrated embodiments of the invention are described with reference to the drawings. In order to provide a better overview, identical or comparable parts or elements or regions are—also in connection with different illustrated embodiments—identified by the same reference symbols, sometimes with the addition of lowercase letters.

In the context of the invention, characteristics that are only described with reference to one illustrated embodiment may also be provided in any other illustrated embodiment of the invention. The invention also includes thus modified illustrated embodiments—even if they are not illustrated in the drawings.

All disclosed characteristics are essential to the invention. The disclosure of the corresponding priority documents (copy of the priority application), as well as of the cited publications and the described devices according to the prior art, is hereby fully incorporated into the disclosure of the present application, namely also for the purpose of including one or more characteristics of these documents in one or more claims of the present application.

The coupling, which is altogether identified by the reference symbol 10 in the figures, is initially described below with reference to the illustrated embodiments illustrated in FIGS. 1 and 1a.

According to FIG. 1, the elastic claw coupling 10 serves for transmitting torque from a not-shown drive element arranged, e.g., at the location 11 to a not-shown load element arranged, e.g., at the location 12 about a geometric axis identified by the reference symbol 13.

The drive element 11 may consist, for example, of an internal combustion engine or an electric motor.

The load element 12 may be formed, for example, by a transmission that is connected to the coupling 12 by means of a not-shown drive element shaft.

The coupling 10 may be realized in the form of a shaft-shaft connection or in the form of a shaft-flange connection or even in the form of a flange-flange connection as described in greater detail further below.

The partially sectioned perspective view illustrated in FIG. 1a, in particular, shows that the coupling 10 comprises a first coupling part 14 and a second coupling part 15. Both coupling parts 14, 15 are realized in the form of a circular-cylindrical toroid. They preferably have the same inside diameter and the same outside diameter, as well as the same axial dimension.

FIGS. 13 and 14, in particular, show that a plurality of radial screw receptacles 35a, 35b, 35c, 35d, 35e, only some of which are identified by reference symbols in an exemplary fashion, are provided on the outer surface area of the two coupling parts 14, 15.

These screw receptacles allow the radial mounting of claws 18, 19.

While the illustrated embodiment illustrated in FIG. 1 represents an example of a coupling 10 in the form of a shaft-shaft connection, the observer of FIG. 1a can clearly gather that the coupling 10 may also be realized in the form of a shaft-flange connection. The flange is identified by the reference symbol 16 in FIG. 1a and illustrated individually in FIG. 5.

The first coupling part 14 according to FIG. 14 also has axial screw receptacles 36a, 36b, 36c, 36d, 36e, only some of which are likewise identified by reference symbols, in addition to the radial screw receptacles 35a, 35b, 35c, 35d, 35e.

These screw receptacles correspond to axial bores 37a, 37b, 37c, 37d, 37e of the mounting flange 16 according to FIG. 15.

The claws 18, 19 can always be radially fixed on the coupling parts 14, 15 regardless of whether the coupling 10 should be realized in the form of a shaft-shaft connection or in the form of a shaft-flange connection.

It should be noted merely for the sake of completeness that the coupling parts 14, 15 may—although not illustrated—either integrally transform into a shaft or be connected to a shaft in a torque-proof fashion on their inside, for example, by means of a screw mounting arrangement or a fitted mounting arrangement, i.e. an interference fit.

According to FIG. la, the claw identified by the reference symbol 19a—a claw of the second type—is rigidly screwed to the second coupling part 15 by means of four screws 22a, 22b, 22c, 22d. The claw 19a therefore is connected to the second coupling part 15 in a torque-proof fashion.

The claw 18a arranged angularly adjacent thereto, namely the claw arranged to the right of the claw 19a in FIG. 1, is rigidly screwed to the first coupling part 14 in an analogous fashion—although this cannot be clearly gathered from FIG. 1—and therefore also referred to as a claw of the first type.

A claw 19 is respectively screwed to the second coupling part 15 and an adjacently arranged claw 18 is respectively screwed to the first coupling part 14 in an angularly alternating sequence.

The claws connected to the first coupling part 14 in a torque-proof fashion are referred to as claws of the first type 18 and the claws connected to the second coupling part 15 in a torque-proof fashion are referred to as claws of the second type 19.

The partially sectioned view in FIG. la already indicates that the claw identified by the reference symbol 19a consists of two parts, namely a foot segment 20 and a head segment 21.

The head segment 21 is illustrated individually in FIGS. 7 and 8. The front view according to FIG. 7 clearly shows that the head segment 21 has two flanks 27 and 28 that are realized in a completely different fashion. The axial length A (FIG. 8) of the head segment 21 essentially corresponds to the sum B (FIG. 5) of the axial lengths of both coupling parts 14 and 15 according to FIG. 1a or is slightly shorter.

The foot segment of a claw 18, 19 is illustrated individually in FIGS. 9-12. These illustrations show that the axial length C corresponds to the axial length A of the head section 20.

FIGS. 4 and 5, in particular, show that the axial length A of the head segment 21 and the axial length C of the foot segment 20 respectively are slightly shorter than the sum B of the axial lengths of the first coupling part 14 and the second coupling part 15.

In this respect, FIGS. 4 and 5 clearly show that a first shoulder 44a is arranged on the first coupling part 14 and a second shoulder 44b is arranged on the second coupling part 15, wherein the head segment 21 and the foot segment 20 end approximately flush with the base of the shoulders 44a, 44b.

In other illustrated embodiments of the invention, however, it is not necessary to arrange corresponding shoulders 44a, 44b on the first and on the second coupling part 14, 15.

The foot section 20 is essentially realized symmetrically referred to a central longitudinal plane M such that the two lateral flanks 30, 31 are realized identically. In other illustrated embodiments of the invention, the two flanks 30, 31 are realized differently.

According to FIG. 7, it can be clearly gathered that the head segment 21 is realized asymmetrically referred to the central longitudinal plane N.

According to FIG. 8, the head segment 21 has a plurality of screw receptacles 29a, 29b, 29c, 29d, 29e, 29f.

According to FIG. 10, the foot segment 20, in contrast, respectively has two screw thread receptacles 33a, 33b and four screw through-openings or screw receptacles 34a, 34b, 34c, 34d.

According to FIG. 1a, as well as FIGS. 4 and 5, the foot segment 20 is initially mounted on the corresponding first or second coupling part 14, 15 with the aid of the screws 22a, 22b in this illustrated embodiment.

The respective head segment 21 is then directly mounted on the corresponding coupling part 14, 15 with the aid of the screws 22c, 22d and at the same time directly fixed on the corresponding foot segment 20 with the aid of the screws 22e, 22f.

In this respect, the illustration in FIG. 2 shows an equidistant arrangement of claws of the first type 18a, 18c, 18c, etc. and claws of the second type 19a, 19b, 19c, etc. All claws 19a, 19b, 19c are respectively realized identically and arranged with the same orientation or alignment.

A space 32a, 32b, 32c for receiving and accommodating elastic bodies, particularly roller bodies, is respectively located between two claws, e.g. between the claws 19a and 18a.

According to FIG. 2 and, in particular, FIG. 6, it can be clearly gathered that elastic and essentially circular-cylindrical roller bodies 25 of a first type and differently designed elastic bodies 26 of a second type are provided.

For example, FIG. 3 and FIG. 6 show that the elastic body 25 of the first type has an essentially circular-cylindrical cross section in its unstressed state. The associated accommodation space 32a, which is defined by the corresponding flank sections identified by the reference symbols 27a, 27b, 30a, 31a in FIG. 6, is also realized essentially circular-cylindrical.

In the illustrated embodiment according to FIG. 6, however, a certain displacement space 38, which allows a displacement of material into the displacement space 38 during a radial deformation of the elastic body 25a under a load element, also forms part of the accommodation space 32a.

In contrast, the elastic body 26 of the second type has a different cross section. It has a retaining section 39 (FIG. 17) that rests in mounting pockets on the claw with two projections 40a, 40b (FIG. 6). The mounting pocket 41a (FIG. 6) is formed by a separate element that may be fixed on the foot segment 20b.

The mounting pocket 40a is formed by a directly corresponding recess 42 on the head segment 21b.

In addition to the retaining section 39, the elastic element 26 of the second type also has a contact section or tensioning section 43 (FIG. 17), by means of which it rests against the respective adjacent claw, e.g. against the claw 19b and its associated flank 46 in FIG. 6.

The elastic element 26a of the second type is prestressed during the radial mounting of the head segment of the claw 19b. This leads to the generation of an angular prestress of both coupling parts 14, 15.

According to the present invention, the claws of the first type 18 and the claws of the second type 19 for being mounted on the different coupling parts 14, 15 are realized identically. They are therefore formed by identical parts such that the stock-keeping is simplified and the manufacturing expenditures are reduced.

According to the invention, the two segments 20, 21 forming a claw 18, 19, namely the foot segment 20 and the head segment 21, furthermore may be respectively made of different materials. For example, the head segment 21 may consist of aluminum or steel and the foot segment 20 may consist of steel. However, it would also be conceivable to choose completely different manufacturing methods. For example, the foot segment may consist of a forged part and the head segment 21 may consist, e.g., of a continuously cast profile that is cut into corresponding lengths.

The invention also allows simple post-processing in order to achieve optimally adapted flank surfaces 30, 31.

The invention furthermore allows the use of identical parts in couplings with different hub diameters. According to an aspect of the invention, this merely requires an adaptation of the mounting surface 24 of the foot part 20 (FIG. 9) to the outer surface area 23 of the first or second coupling part 14, 15. If the outside diameters of the first coupling part 14 and the second coupling part 15 differ and therefore result in different curvatures of the outer surface area, a mere adaptation of the mounting surface 24 makes it possible to use an otherwise identical foot segment 20. The processing effort can be significantly reduced in comparison with the prior art because the mounting surface 24 can be adapted in order to change its concavity, i.e.

the type of curvature or the degree of curvature, by simply post-processing an already existing foot segment 20.

The elastic body of the second type, which is altogether identified by the reference symbol 26 in FIGS. 16 and 17, is described in greater detail below with reference to FIGS. 16 and 17.

The elastic body 26 of the second type has an axial length X (FIG. 16) that essentially corresponds to the axial length A of the head segment 21. For the sake of completeness, it should be noted that the axial length of the circular-cylindrical roller bodies of the elastic bodies 25 of the first type likewise corresponds to the length X of the elastic bodies 26 of the second type.

According to FIG. 17, the elastic body 26 of the second type has an essentially truncated triangular cross section. A tensioning section 43 extends away from a base of sorts, which is referred to as retaining section 39, with a diminishing width. Two mounting sections 45a, 45b, which are also referred to as projections 40, are arranged on the retaining section 39. These projections are respectively inserted into the corresponding mounting pockets 41a, 41b on the head segment 21 of the corresponding claw and into a corresponding mount on the foot segment 20.

In the installed state illustrated, for example, in FIG. 6, the corresponding flank 28 (FIG. 7) of the head segment 21c illustrated in FIG. 6 becomes a prestressing surface 46. As the head segment 21 continues to radially approach the rotational axis 13, i.e. during the installation of the head segment 21 on the coupling 10, the prestressing surface 46 comes in contact with the face 47 (FIG. 17) of the elastic body 26 of the second type and angularly compresses the elastic body 26 of the second type.

It should be noted merely for the sake of completeness that the claw identified by the reference symbol 18a in FIG. 6, particularly its head segment 21b, can be initially installed, if applicable, with the elastic body 26a of the second type already inserted therein.

The head segment of the adjacent claw 19b, which is identified by the reference symbol 21c in FIG. 6, only can be radially installed after this mounting has taken place and thereby ensure an angular compression of the elastic body 26a during the course of its continuous radial approach of the rotational axis 13.

The first coupling part 14 and the second coupling part 15 are—in the load-free state—prestressed relative to one another as a result of the compression of all elastic bodies of the second type 26a, 26b, 26c, 26d, 26e. This likewise ensures that the elastic bodies of the first type 25a, 25b, 25c, 25d, 25e, etc. are also at least slightly prestressed.

A separation of the surfaces of the claws such as, e.g., the flanks 27a, 27b according to FIG. 6 from the elastic body 25a of the first type, which is identified by the reference symbol 25a in FIG. 6, can be prevented during sudden load changes of the type potentially occurring during the operation of the coupling, particularly if the coupling 10 is used in ore mills, stone mills, steel mills or the like, i.e. in applications, in which abrupt rebounds frequently occur.

Two accommodation spaces 32a, 32b of the coupling 10, which are arranged angularly adjacent, are respectively realized differently. According to FIG. 6, in particular, accommodation spaces of a first type 32a, 32c, 32e, etc. have an essentially circular cross section and are in this respect adapted to the circular-cylindrical cross section of the elastic bodies 25 of the first type.

Accommodation spaces of a second type 32b, 32d, 32f are essentially realized triangular and in this respect approximated to the cross-sectional contour of the elastic bodies 26 of the second type.

FIG. 6, in particular, shows that the centers of the elastic bodies 25 of the first type and the elastic bodies 26 of the second type essentially lie on the same radius R about the rotational axis 13.

According to an advantageous embodiment of the invention, the foot segment 20 is realized in the form of a forged part, wherein the mounting surface 24 and, if applicable, one or more flanks 30, 31 can be produced by means of a special forging process. This makes it possible to provide a foot segment 20 of the claw 18, 19 that requires no post-processing.

The head segment 21 is made of a different material, preferably of aluminum, and may be formed, e.g., by a continuously cast profile.

1. An elastic claw coupling for transmitting torque from a drive element to a load element, comprising:
a first coupling part assigned to the drive element and a second coupling part assigned to the load element, both of which rotate about a common rotational axis;
radially mountable angularly adjacent claws on both coupling parts and extending radially outward from the respective coupling part, as well as axially so as to achieve an axial overlap with the respective other coupling part, each claw forming with an angularly adjacent claw a respective accommodation space; and
respective elastic in the accommodation spaces, the claws of both coupling parts are being identical.

2. An elastic claw coupling for transmitting torque from a drive element to a load element, comprising:
a first coupling part assigned to the drive element and a second coupling part assigned to the load element, both of which rotate about a common rotational axis;
radially mountable angularly adjacent claws on both coupling parts and extending radially outward from the respective coupling part, as well as axially so as to achieve an axial overlap with the respective other coupling part, each claw forming with an angularly adjacent claw a respective accommodation space; and
respective elastic bodies in the accommodation spaces, the claws each being divided into at least two claws segments, the claws of both coupling parts having at least one identically designed claws segment.

3. The elastic claw coupling according to claim 1, wherein a claw comprises at least two claws segments, wherein the claw particularly is radially divided into a head segment and a foot segment.

4. The elastic claw coupling according to claim 1, wherein the head segment and the foot segment respectively form a section of a contact surface for the elastic body.

5. The elastic claw coupling according to claim 3, wherein the foot segment and the head segment are designed for being radially mounted on one another.

6. The elastic claw coupling according to claim 3, wherein the foot segment and the head segment consist of different materials.

7. The elastic claw coupling according to claim 3, wherein the head segment is realized asymmetrically referred to a central longitudinal plane.

8. The elastic claw coupling according to claim 7, that wherein an angularly alternating orientation of the head segments is realized.

9. The elastic claw coupling according to claim 3, wherein the foot segment has a concave mounting surface that is cylindrically curved and serves for contacting a cylindrical surface area of the coupling part.

10. The elastic claw coupling according to claim 1, wherein each of the coupling parts is formed by a toroid that has radial screw receptacles for mounting the claws.

11. The elastic claw coupling according to claim 10, wherein at least one coupling part has additional axial screw receptacles for the installation of a mounting flange, wherein a radial dimension of the mounting flange exceeds a radial dimension of the toroid.

12. A group of foot segments of claws for elastic claw couplings according to claim 2, wherein a first foot segment has a concave mounting surface that is cylindrically curved along a first radius and serves for contacting a cylindrical surface area of the coupling part, and in that a second foot segment is with the exception of the design of the mounting surface realized identically to the first foot segment and has a concave mounting surface that is cylindrically curved along a second radius that differs from the first radius and serves for contacting a surface area of the coupling part that is realized cylindrically along the second radius.
